(19) United States
(12) Patent Application Publication
(10) Pub. No.: US 2004/0247064 A1
(43) Pub. Date: Dec. 9, 2004

(54) Differential detector

(76) Inventors: Chun Hua Yang, Singapore (SG); Theng Tee Yeo, Singapore (SG); Masayuki Tomisawa, Singapore (SG)

Correspondence Address: QUARLES & BRADY LLP, 411 E. WISCONSIN AVENUE, SUITE 2040, MILWAUKEE, WI, 53202-4497, US

(21) Appl. No.: 10/808,698

(22) Filed: Mar. 25, 2004

(30) Foreign Application Priority Data
Mar. 27, 2003 (SG) 200301513-8

(51) Int. Cl. H04L 27/14

(52) U.S. Cl. 375/350

(57) ABSTRACT

A differential detector is disclosed which comprises: a frequency converter (230) arranged to convert an input signal into demodulated baseband signals; samplers (217, 218) arranged to sample said demodulated baseband signals at a sampling frequency to provide sampled signals; a demodulator (231) arranged to demodulate the sampled signals to provide a demodulated signal; and a data slicer (310) arranged to sense an envelope of the demodulated signal to provide an envelope signal and a comparator (224) arranged provide an output signal dependent upon the demodulated signal and the envelope signal.

### FIELD OF THE INVENTION

The present invention relates to a differential detector suitable for use in a GMSK or GFSK modulation scheme.

### BACKGROUND OF THE INVENTION

GMSK or GFSK modulation are widely adopted approaches by many wireless communication standards such as GSM, DECT and Bluetooth. There are several demodulation structures for GFSK including coherent demodulation and differential demodulation. Carrier recovery for coherent demodulation increases the carrier acquisition time to a relatively high degree. Therefore, for a burst-mode communication system, differential demodulation is often preferred. In a radio communication system due to either discrepancy between the oscillators at the transmitter and the receiver, or the Doppler effect, frequency offset between the transmitter and receiver usually occurs, which degrades the performance of the system. In order to ensure a satisfactory BER performance, it is important to compensate for the effect of frequency offset. This is particularly true for the case of burst mode communication systems where a fast and robust method to estimate and eliminate the effect of frequency offset is deemed necessary.

FIG. 1 shows the typical structure of a GFSK transmitter which comprises a Gaussian low pass filter (LPF) and a FM modulator. The response p(t) at time t of the Gaussian filter to a unit rectangular pulse with duration T_{b} is given by

$$p ( t ) = Q [ \frac{2 π B}{\sqrt{ln 2}} ( t - 0.5 {T}_{b} ) ] - Q [ \frac{2 π B}{\sqrt{ln 2}} ( t + 0.5 {T}_{b} ) ] \qquad ( 1 )$$

where

$$Q ( t ) = {\int }_{t}^{∞} \frac{1}{\sqrt{2 π}} {ⅇ}^{- {τ}^{2} / 2} ⅆ τ ,$$

τ is a dummy variable of the integral, and B is the 3-dB bandwidth of the Gaussian filter.

The phase of the GFSK signal is given by:

$$Φ ( t ) = 2 π {k}_{m} {\sum }_{i = - ∞}^{∞} {b}_{i} {\int }_{- ∞}^{t} p ( τ - i {T}_{b} ) ⅆ τ \qquad ( 2 )$$

where kₘ is the modulation index and bᵢ is the transmitted signal.

A prior art differential detector for a GFSK signal is illustrated in FIG.2, which includes a frequency converter 230 arranged to convert the input signal r(t) into a demodulated baseband signal, a pair of samplers 217, 218, a demodulator 231 and a comparator 224. The frequency converter 230 further includes a multiplexer 210 for receiving and converting the input signal r(t) into two primary orthogonal signals, a VCO 214 for providing a local oscillating signal, a phase shifter 213 for phase shifting (by 90 degrees) the local oscillating signal from the VCO 214, a pair of multipliers 211 and 212 for respectively multiplying the two primary orthogonal signals from the multiplexer 210 with the local oscillating signal from VCO 214 and the phase shifted signal from the phase shifter 213 to yield two orthogonal signals (I(t) and Q(t)), and a pair of low-pass filters 215 and 216 coupled with multipliers 211 and 212 for filtering the high frequency components of the two signals I(t) and Q(t).

Without considering the distortion introduced by the channel, the received signal r(t)at intermediate frequency f_{IF} is

r(t)=A cos[2π(f_{IF}+Δ_{f})t+Φ(t)]+n(t), (3)

where Δ_{f} is the frequency offset and n(t) is white Gaussian noise, and A is the signal amplitude. By passing through the frequency converter 230 and samplers 217 and 218 which sample the two orthogonal components of the demodulated baseband signal, the digital in-phase and quadrature-phase components of the demodulated baseband signal Iₙ, Qₙ are:

Iₙ=A cos[2πΔ_{f}nTₛ+Φ(nTₛ)+θ]

Qₙ=−A sin[2πΔ_{f}nTₛ+Φ(nTₛ)+θ] (4)

where

$${T}_{s} = \frac{{T}_{b}}{K}$$

is the sampling duration and θ is the phase offset produced by the receiver VCO 214.

The demodulator 231 in FIG. 2 includes a pair of delay units 219 and 220 coupled with the pair of samplers 217 and 218 for respectively delaying the outputs from the samplers to generate delayed signals I((n−1)Tₛ) and Q((n−1)Tₛ) in which Tₛ represents a sampling period, and a pair of multipliers 221 and 222 coupled with the pair of delay units 219 and 220 to cross-multiply the outputs from the pair of delay units with the outputs from the pair of samplers 217 and 218, to give two signals I(nTₛ)Q((n−1)Tₛ) and I((n−1)Tₛ)Q(nTₛ). After summation by the adder 223, the output of the demodulator 231 is

yₙ=I(nTₛ)Q((n−1)Tₛ)−I((n−1)Tₛ)Q(nTₛ)=A² sin (2πΔ_{f}Tₛ+ΔΦ) (5)

where ΔΦ=Φ(nTₛ)−Φ((n−1)Tₛ) represents the phase difference during a sampling period. Under ideal conditions, the frequency offset Δ_{f} vanishes and the detector output is A² sin(ΔΦ), which is fed to a comparator 224 with a zero threshold. Logic “1” and “0” of the transmitted signal are determined by the following rule:

$${\hat{b}}_{n} = \{ \begin{matrix}1 , & {y}_{n} > 0 \\ 0 , & {y}_{n} \leq 0\end{matrix} \qquad ( 6 )$$

where \hat{b}ₙ is the output of the threshold comparator at t=nTₛ.

The detector output yₙ in Eqn(5) is the sine of the change in phase of the signal r(t) over one sampling duration plus a frequency offset term. Usually, the frequency offset is non-zero, for example, in the Bluetooth standard the transmitter is allowed to have a frequency offset up to ±75 kHz and a frequency drift rate up to 400 Hz/μs. Using the decision rule given in Eqn.(6), the performance of the detector depicted in FIG. 2 is degraded when the frequency offset is non-zero.

In U.S. Pat. No. 5,867,059, a method based on Fast Fourier Transform operation is disclosed to estimate the abovementioned frequency offset which is compensated by adjusting the -frequency of the local oscillator. A feedback loop circuit is included to compensate for the frequency offset at the expense of increased complexity.

A one-bit differential demodulator is disclosed in U.S. Pat. No. 5,448,594 in which at least one Butterworth and one IIR low pass filter are combined to estimate the value of a threshold for a comparator, which is caused by the frequency offset. For burst-mode operation, this method is not fast enough to track the value of the threshold related to the frequency offset, especially in Bluetooth where there are only 4 preambles available.

It is an object of the present invention to provide a novel method and apparatus to alleviate the distortion caused by frequency offset.

### SUMMARY OF THE INVENTION

In accordance with one aspect of the present invention, there is provided a differential detector comprising: a frequency converter arranged to convert an input signal into a demodulated baseband signal; sampling means arranged to sample said demodulated baseband signal at a sampling frequency to provide a sampled signal; a demodulator arranged to demodulate the sampled signal to provide a demodulated signal; and frequency offset sensing means arranged to sense an envelope of the demodulated signal to provide an offset signal indicative of a frequency offset of the input signal.

Preferably, said sensing means comprises: means arranged to track the envelope of said demodulated signal from said demodulator and provide a tracking signal; and a filter arranged to low pass filter the tracking signal to provide the offset signal.

Typically, said filter coefficient generator reduces the filter coefficient as a function of time.

Typically, said filter has a bandwidth which decreases as a function of time.

Typically, said sensing means further comprises a reset signal generator arranged to detect the start of input data transmission and reset the sensing means.

Typically, the generator is arranged to detect signal power to detect the start of transmission.

Preferably, the demodulator comprises power normalizing means arranged to generate a power signal from the sampled signal and provide a normalized demodulated signal to the generator.

Preferably, the demodulator includes power normalizing means arranged to generate a power signal from the sampled signal and provide a normalized demodulated signal to the sensing means.

Typically, the sensing means further comprises a comparator arranged to compare said demodulated signal with a threshold provided by the offset signal to provide an output signal.

In accordance with another aspect of the present invention, there is provided a differential detector comprising: a frequency converter arranged to convert an input signal into a demodulated baseband signal; sampling means arranged to sample said demodulated baseband signal at a sampling frequency to provide a sampled signal; a demodulator arranged to demodulate the sampled signal to provide a demodulated signal; and a filter arranged to filter the demodulated signal to provide a filtered signal indicative of a frequency offset of the input signal and wherein the filter is arranged to have a bandwidth which decreases as a function of time.

### BRIEF DESCIPTION OF THE DRAWINGS

Embodiments of the invention will now be discussed, by way of example, with reference to the accompanying drawings, in which:

FIG. 1 schematically illustrates a GFSK transmitter of the prior art;

FIG. 2 schematically illustrates a prior art GFSK differential detector;

FIG. 3 schematically illustrates a first embodiment of a differential detector of the present invention;

FIG. 4 is a schematic block diagram illustrating the structure of a data slicer of the embodiment of FIG. 3;

FIG. 5. is a flow chart of the algorithm for computing the low frequency component caused by the frequency offset in the data slicer of FIG. 4.

FIG. 6 schematically illustrates a second embodiment of a differential detector of-the present invention;

FIG. 7 is a schematic block diagram illustrating the structure of a data slicer of second embodiment of the present invention; and

FIG. 8 is a flow chart of the algorithm for computing the low frequency component caused by the frequency offset in the data slicer of FIG. 7.

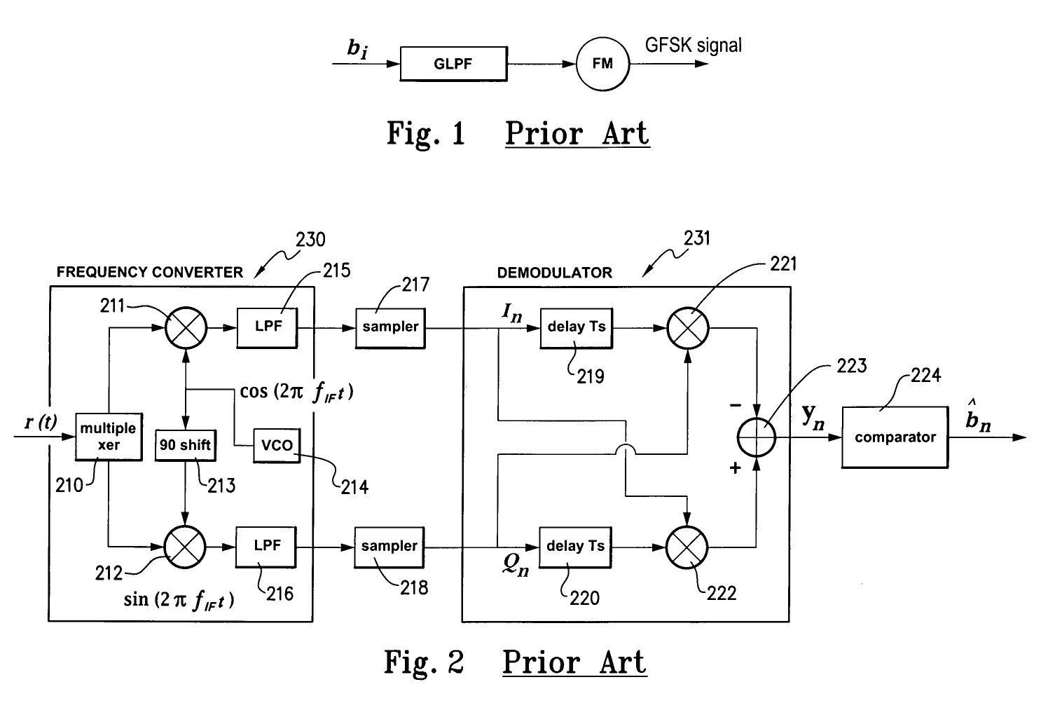

### DETAILED DESCRIPTION OF THE PREFERRED EMBODIMENTS OF THE INVENTION

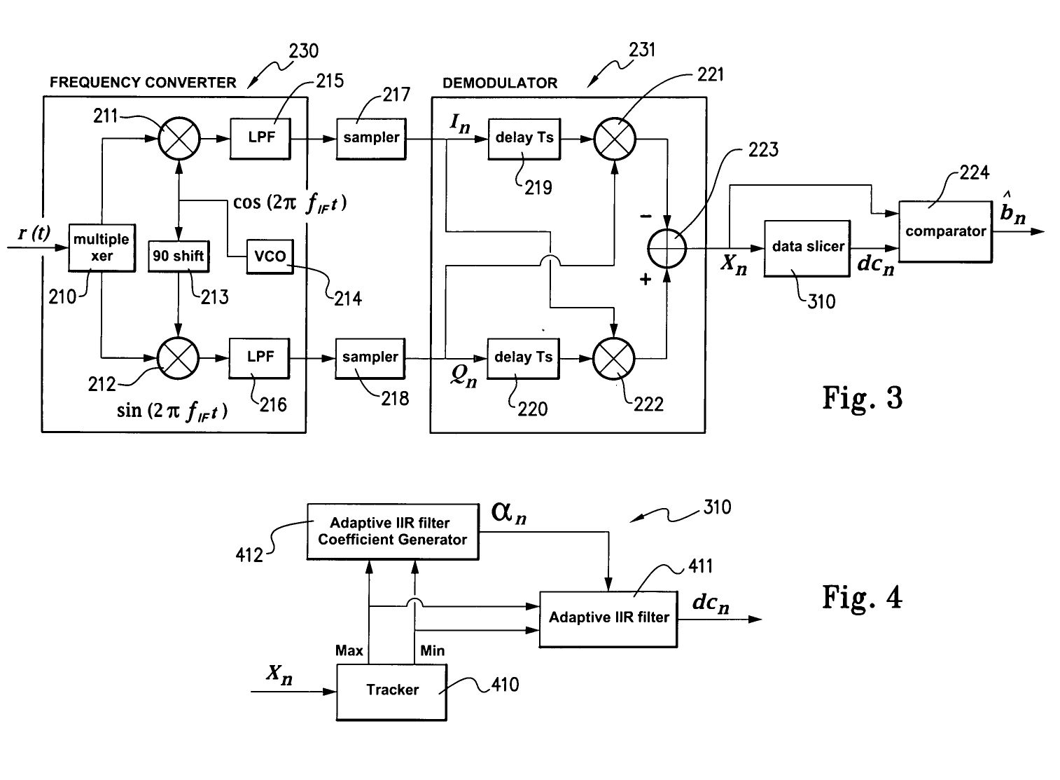

A first embodiment of a differential detector for a GFSK modulated signal is shown in FIG. 3. The detector includes a frequency converter 230, a pair of samplers 217 and 218, a demodulator 231, a data slicer 310 and a comparator 224. The frequency converter 230, the pair of samplers 217 and 218 and the demodulator 231 are the same as the prior art illustrated in FIG. 2, and will not be explained further. The demodulator output is

xₙ=I(nTₛ)Q((n−1)Tₛ)−I((n−1)Tₛ)Q(nTₛ)=A² sin(2πΔ_{f}Tₛ+ΔΦ) (7)

which is the sine of the change in phase of the received signal r(t).

When 2πΔ_{f}Tₛ is small, the expression of Eqn (7) can be approximated by:

xₙ≈A²(2πΔ_{f}Tₛ cos ΔΦ+sin ΔΦ) (8)

The expectation value of xₙ in Eqn(8) yields:

E[xₙ]=A²(2πΔ_{f}TₛE[cos ΔΦ]+E[sin ΔΦ]) (9)

For an one-bit differential detector, the phase difference can be approximated by the following equation:

ΔΦ≈bₖ₊₁θ₁+bₖθ₀+bₖ₋₁θ₋₁ (10)

where θᵢ is the result of integration over one sampling duration generated by the ith symbol element.

For the Bluetooth system, the phase difference ΔΦ over one symbol duration corresponding to all possible combinations of input data is tabulated in Table 1.

TABLE 1
phase difference for one-bit differential detector

| bᵢ₊₁ | bᵢ | bᵢ₋₁ | ΔΦ (degree) |
|---|---|---|---|
| 0 | 0 | 0 | −57.6 |
| 0 | 0 | 1 | −45.45 |
| 1 | 0 | 0 | −45.45 |
| 1 | 0 | 1 | −33.3 |
| 0 | 1 | 0 | 33.30 |
| 0 | 1 | 1 | 45.45 |
| 1 | 1 | 0 | 45.45 |
| 1 | 1 | 1 | 57.60 |

Under the assumption of equally distributed input data, it can be seen that E[sin ΔΦ]=0. From Eqn(8), the frequency offset produces a low frequency signal A²2πΔ_{f}Tₛ cos ΔΦ at the output of differential demodulator. The threshold signal for the comparator needs to be non-zero due to the frequency offset. A data slicer 310 is added in FIG. 3 to adaptively track the low frequency signal A²2πΔ_{f}T_{S}cos ΔΦ, which is used as the threshold level for the following comparator 224.

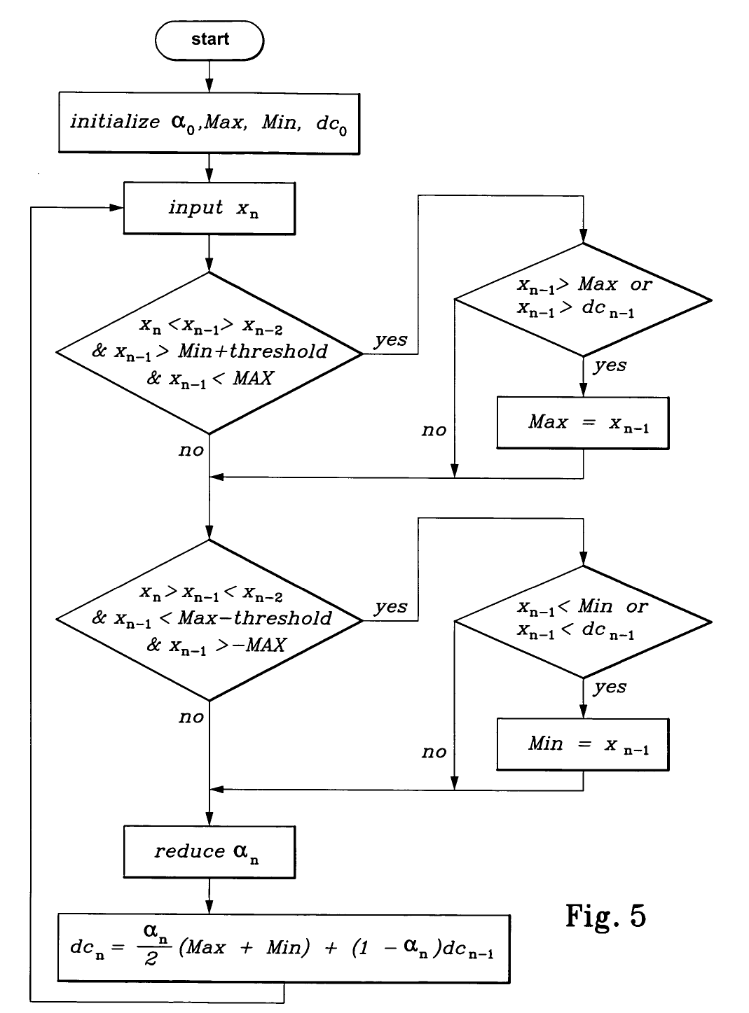

The implementation of the data slicer of the first embodiment is explained with reference to FIGS. 4 and 5.

In the prior art, such as U.S. Pat. No. 5,448,594, entitled “One-bit Differential Demodulator”, a low pass filter is designed to track the low frequency signal A²2πΔ_{f}T_{S} cos ΔΦ directly. The disadvantage of this method :is that if the bandwidth of the filter is excessive, the resultant output will contain too much high frequency content, which endangers the proper operation of the differential detector as a whole. If the bandwidth of the filter is insufficient, a long time is needed to capture the burst data.

Instead of tracking the low frequency component directly, in the present invention, the envelope of the detector output xₙ is tracked and low-pass filtered to obtain the low frequency component. As the envelope of the demodulated signal tends to be more stable than the demodulated signal itself, a LPF with a much wider bandwidth can be employed to give a fast tracking without introducing too much disturbance. A separate feature which allows a further improvement in performance, i.e., capture of the data in a shorter time while keeping a good BER performance simultaneously, is the use of an adaptive !low pass filter. During the beginning of the data reception, the filter can be allowed to begin operation at a wider bandwidth. This is useful in terms of capturing the burst data quickly. As more data is received, the bandwidth of the filter is reduced gradually in order to suppress the high frequency components.

A block diagram of the structure of the data slicer 310 of the first embodiment is depicted in FIG. 4 and is composed of three main functional blocks: An adaptive IIR filter coefficient generator 412, tracker 410, and adaptive IIR filter 411. The operation of the data slicer is described by the flow chart in FIG. 5. At the beginning of the loop, the parameters α, Max, Min and dc are preset to an appropriate value (e.g., zero), in which parameter α is a coefficient of the IIR filter 411, Max and Min are respectively the values of positive and negative peaks of the envelope of the demodulator output xₙ, and dc is the output of the IIR filter 411, which is the low frequency component of the envelope of the demodulator output xₙ₊. The values of the positive and negative peaks Max,Min of the input signal xₙ are updated by using tracker 410 based on the following rules:

if xₙ<xₙ₋₁>xₙ₋₂ and xₙ₋₁>Min+threshold and xₙ₋₁<MAX, And if xₙ₋₁>Max or xₙ₋₁>dcₙ₋₁, then Max=xₙ₋₁

if xₙ>xₙ₋₁<xₙ₋₂ and xₙ₋₁<Max−threshold and xₙ₋₁>−MAX, And if xₙ₋₁<Min or xₙ₋₁<dcₙ₋₁, then Min=xₙ₋₁

where, xₙ, xₙ₋₁, xₙ₋₂ are samples of the demodulator output at time n, time n−1 and time n−2, respectively. The parameter “threshold” is a user-defined constant reflecting the smallest gap between the positive and negative peaks. The parameter “MAX” is also a user-defined constant, wherein the tracked positive and negative peaks are confined within the range (−MAX, MAX). Moreover, “threshold” and “MAX” are proportional to the sampling duration, the modulation index being employed, as well as the amplitude of the input signal. The explanation of the above rule for providing the max and min peaks of the envelope is described in details as follows:

With the constraints xₙ<xₙ₋₁>xₙ₋₂ and xₙ>xₙ₋₁<xₙ₋₂ applied, only the local maximum and minimum are obtained. However, the local maximum or minimum differ from the positive or negative peaks of xₙ. In addition to the aforementioned inequality constraints, the positive (negative) peaks must be chosen from a set of local maximum (minimum) with the condition xₙ₋₁>Min+threshold (xₙ₋₁<Max−threshold) applied. Due to the properties of GFSK modulation, the maximum absolute phase difference Δφₘₐₓ is constrained so is the maximum absolute value of x_{n,max}≈A²(2πΔ_{f}T_{S} cos Δφₘₐₓ+sin Δφₘₐₓ), where Δ_{f}=Δ_{f max}x_{n,max} is denoted by the user defined constant MAX. Due to the presence of noise and interference, the demodulated signal xₙ may be larger than MAX or smaller than −MAX. So the tracked positive and negative peaks Max and Min are confined within the range (−MAX, MAX). In fact, there are many kinds of techniques for tracking the positive and negative envelopes of the demodulated signals.

Adaptive IIR filter coefficient generator 412 adjusts the coefficient αₙ of the IIR filter 411 at time n to reduce the bandwidth of the adaptive IIR filter. The coefficient αₙ at time n is reduced as a function of time. For example,

$${α}_{n} = \frac{31}{32} {α}_{n - 1} + \frac{1}{32} * \frac{1}{256} ,$$

and αₙ is reset to an initialization value (i.e., α₀ which is a predetermined constant) and is monotonically reduced until the end of transmission. The maximum and the minimum values Max,Min and the parameter αₙ are then used as the inputs to the adaptive lIR filter 411 for the calculation of the low frequency component of the envelope of the demodulator output xₙ according to the following equation

$$d {c}_{n} = ( 1 - {α}_{n} ) d {c}_{n - 1} + \frac{{α}_{n}}{2} ( Max + Min ) . \qquad ( 11 )$$

where, dcₙ is the low frequency component of the envelope of the signal xₙ at time n, dcₙ₋₁ is the low frequency component of the envelope of the signal xₙ₋₁ at time n−1, αₙ is the coefficient of filter at time n.

The above process is repeated as long as the differential detector is in operation. The signal dcₙ is used as an input to a comparator 224 of FIG. 3 as a threshold signal. The following rule determines a logic “1” or “0” to be transmitted:

$${\hat{b}}_{n} = \{ \begin{matrix}1 , & {x}_{n} > d {c}_{n} \\ 0 , & {x}_{n} \leq d {c}_{n}\end{matrix} \qquad ( 12 )$$

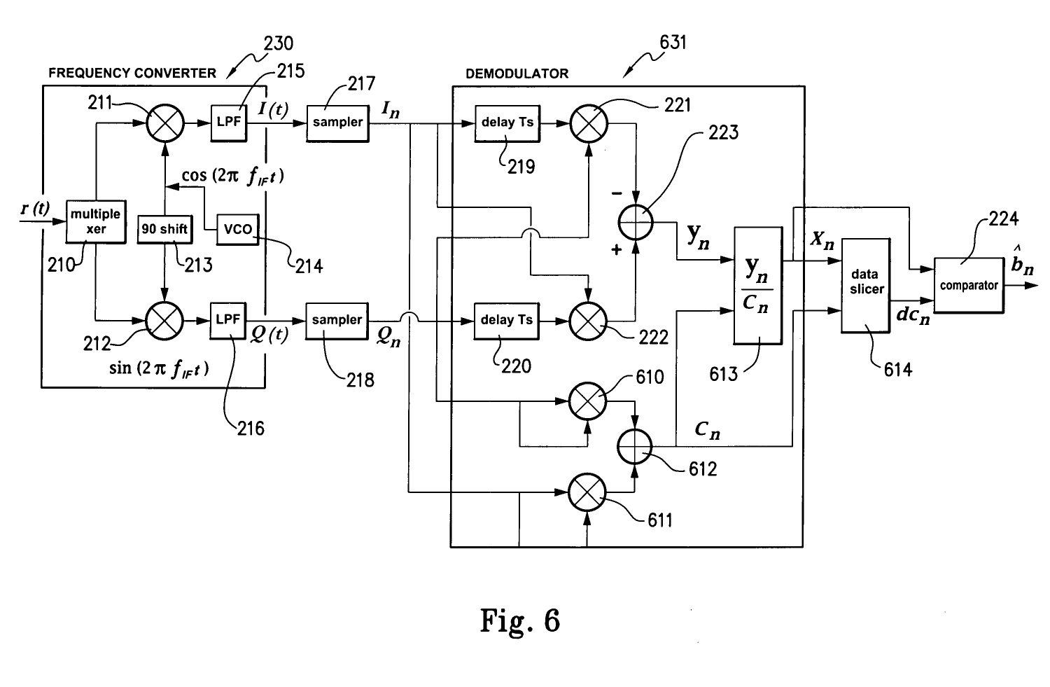

With reference to FIGS. 6-8, the second embodiment of present invention will be explained. The detector includes a frequency converter 230, a pair of samplers 217 and 218, a dermodulator 631, a data slicer 614 and a comparator 224. The frequency converter 230 is the same as that of the first embodiment illustrated in FIG. 3, while the demodulator of the second embodiment is different from that of the first embodiment. It can be seen from FIG. 6 that the demodulator 631 further comprise means for normalizing the output yₙ from the adder 223, which includes a pair of self multipliers 610 and 611 coupled to the pair of samplers 217 and 218 for providing a squared output of the signals Iₙ and Qₙ, an adder 612 for summing the output from the pair of multipliers 610 and 611 to provide a signal Cₙ=I²(nTₛ)+Q²(nTₛ) indicative of the signal power, and a divider 613 for normalizing the output yₙ from the adder 223 by dividing by the signal power Cₙ, yielding:

$${x}_{n} = \frac{I ( {nT}_{s} ) Q ( ( n - 1 ) {T}_{s} ) - I ( ( n - 1 ) {T}_{s} ) Q ( {nT}_{s} )}{{I}^{2} ( {nT}_{s} ) + {Q}^{2} ( {nT}_{s} )} = \\ sin ( 2 π {Δ}_{f} {T}_{s} + Δ Φ ) \qquad ( 13 )$$

The sine of the change in phase of the received signal r(t) is thus obtained and is independent of the signal power. When 2πΔ_{f}Tₛ is small, the expression of Eqn(13) can be approximated by:

xₙ≈2πΔ_{f}Tₛ cos ΔΦ+sin ΔΦ (14)

The expectation value of xₙ in Eqn(14) yields:

E[xₙ]=2πΔ_{f}TₛE[cos ΔΦ]+E[sin ΔΦ]

For a one-bit differential detector, the phase difference can be approximated by the-following equation:

ΔΦ≈bₖ₊₁θ₁+bₖθ₀+bₖ₋₁θ₋₁ (16)

where θᵢ is the result of integration over one sampling duration generated by the ⁱth symbol element.

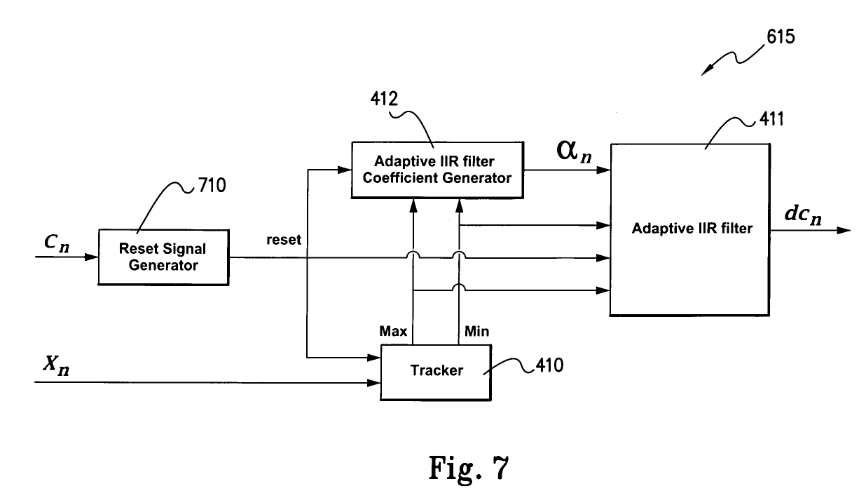

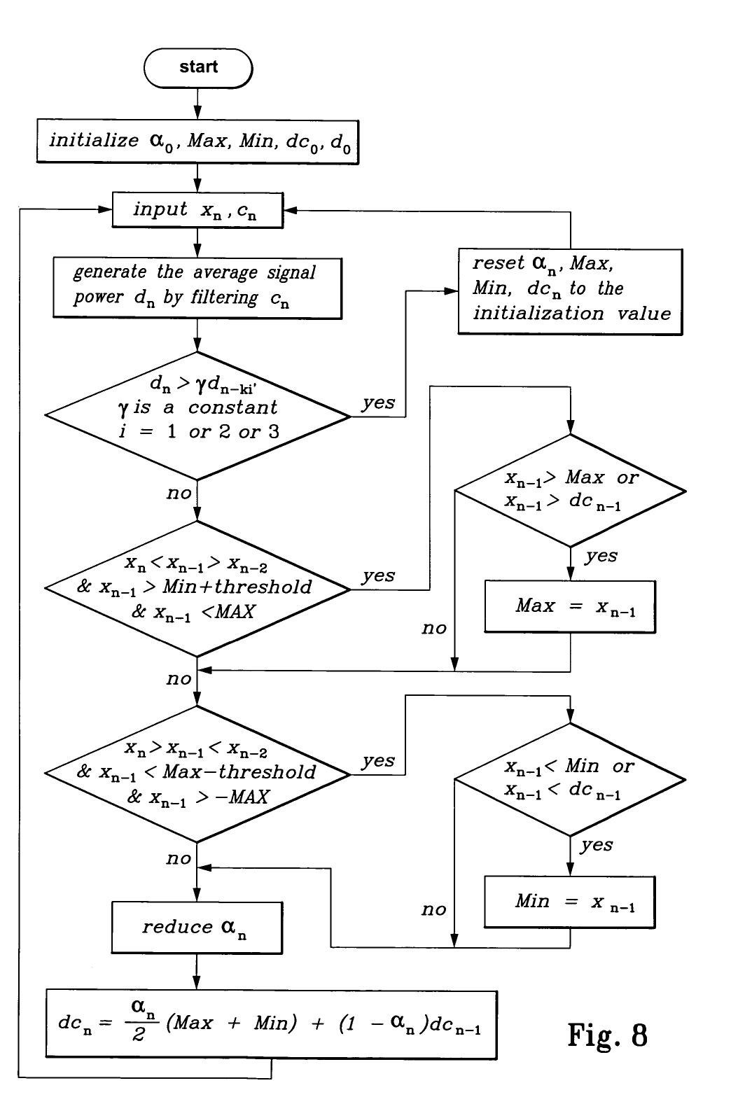

For the reason given in the first embodiment E[sin ΔΦ]=0. From Eqn(14), the frequency offset produces a low frequency signal 2πΔ_{f}TₛcosΔΦ at the output of differential demodulator. The threshold signal for the comparator 224 is non-zero due to the frequency offset. Data slicer 614 is used in FIG. 6 to adaptively track the low frequency signal 2πΔ_{f}Tₛ cos ΔΦ, which is used as the threshold level for the following comparator 224. The detailed structure of the data slicer 614 is shown in FIG. 7. The difference between the data slicer of FIGS. 4 and 7 is that the data slicer 614 further comprises a reset signal generator 710 which is used to detect the start of data transmission and generate a reset signal to initiate the adaptive IIR filter coefficient generator 412, tracker 410 and adaptive IIR filter 411. In order to allow the receiver to operate properly in a burst mode communication system, it is important to determine when the burst data transmission starts. The reset signal generator 710 includes a simple LPF filter which is used to calculate the average value of the signal power output cₙ from the demodulator 631. FIG. 8 shows the flow chart of the operation of the data slicer 614 of FIG. 6. Prior to the start of data transmission, the parameters α, Max, Min, dc and d are reset to pre-defined initialization values, in which parameter d is the output of the simple LPF filter of the reset signal generator 710. Then the signal power cₙ from the demodulator 631 is low-pass filtered by the reset signal generator 710 to provide an averaged output dₙ=σdₙ₋₁+(1−σ)cₙ, where the value of σ is application dependent, and in the present embodiment it is a constant in the range of (0,1).

The average value dₙ of the signal power cₙ is compared with its previous values dₙ₋₁ at the symbol rate to determine the start of the data transmission. In this embodiment, the average value dₙ is compared with its weighted previous values γdₙ₋ₖₗ, in which γ represents a weighting factor of dₙ₋ₖₗ, K is the oversampling factor which is defined in Eqn.(3) and I is an integer (I=1, 2, 3 . . . ).

The the positive and negative peaks of the demodulator output xₙ are then tracked by tracker 410 based on the following rules:

if xₙ<xₙ₋₁>xₙ₋₂ and xₙ₋₁>Min+threshold and xₙ₋₁<MAX, And if xₙ₋₁>Max or xₙ₋₁>dcₙ₋₁, then Max=xₙ₋₁

if xₙ>xₙ₋₁<xₙ₋₂ and xₙ₋₁<Max−threshold and xₙ₋₁>−MAX, And if xₙ₋₁<Minor xₙ₋₁<dcₙ₋₁, then Min=xₙ₋₁

Since the amplitude of the input signal is normalized in the demodulator 631 of FIG. 6, the two pre-determined constants “threshold” and “MAX” are only proportional to the sampling duration, the GFSK modulation index being employed. The maximum and the minimum values Max,Min are used as the inputs to the adaptive IIR filter 411 for the calculation of the low frequency component according to the following equation

$$d {c}_{n} = ( 1 - {α}_{n} ) d {c}_{n - 1} + \frac{{α}_{n}}{2} ( Max + Min ) . \qquad ( 17 )$$

The bandwidth of the adaptive IIR filter is reduced gradually by adjusting the coefficient αₙ in the coefficient of adaptive. IIR filter generator 412.. The coefficient αₙ is reduced as a function of time, for example,

$${α}_{n} = \frac{31}{32} {α}_{n - 1} + \frac{1}{32} * \frac{1}{256} .$$

The above process is repeated as long as the differential detector is in operation. The signal dcₙ is used as an input to a comparator 224 of FIG. 6 as a threshold signal. The following rule determines logic “1” or “0” to be transmitted:

$${\hat{b}}_{n} = \{ \begin{matrix}1 , & {x}_{n} > d {c}_{n} \\ 0 , & {x}_{n} \leq d {c}_{n}\end{matrix} \qquad ( 18 )$$

In summary, a differential detector has been disclosed which can reduce the distortion caused by the frequency offset in order to improve the BER performance. The scope of the invention is not restricted to the described embodiments. For example, a subtractor can be disposed following the slicer in place of the comparator, for subtracting the output of the data slicer from the demodulated signal of the demodulator and determines logic “1” or “0” depending on whether the result of the subtracting is larger than zero or not. Alternatively, the output from the data slicer need not be further utilized in the detector, but, may form a signal output to other circuitry.

Numerous other modifications, changes, variations, substitutions and equivalents will therefore occur to those skilled in the art without departing from the scope of the present invention as defined by the following claims.

1. A differential detector comprising:
a frequency converter arranged to convert an input signal into a demodulated baseband signal;
sampling means arranged to sample said demodulated baseband signal at a sampling frequency to provide a sampled signal;
a demodulator arranged to demodulate the sampled signal to provide a demodulated signal; and
frequency offset sensing means arranged to sense an envelope of the demodulated signal to provide an offset signal indicative of a frequency offset of the input signal.

2. A differential detector according to claim 1, wherein said sensing means comprises:
means arranged to track the envelope of said demodulated signal from said demodulator and provide a tracking signal; and
a filter arranged to low pass filter the tracking signal to provide the offset signal.

3. A differential detector according to claim 2, wherein said filter is an adaptive IIR filter.

4. A differential detector according to claim 2, wherein said sensing means further comprises a filter coefficient generator

5. A differential detector according to claim 4, wherein said filter coefficient generator reduces the filter coefficient as a function of time.

6. A differential detector according to claim 5, wherein said filter coefficient generator adjusts the coefficient of filter according to the following:
$${α}_{n} = \frac{31}{32} {α}_{n - 1} + \frac{1}{32} * \frac{1}{256} ,$$
wherein αₙ is the filter coefficient at time n, αₙ₋₁ is the filter coefficient at time n−1.

7. A differential detector as claimed in claim 2 wherein said filter has a bandwidth which decreases as a function of time.

8. A differential detector according to claim 1 wherein said sensing means further comprises a reset signal generator arranged to detect the start of input data transmission and reset the sensing means.

9. A differential detector as claimed in claim 8 wherein the generator is arranged to detect signal power to detect the start of transmission.

10. A differential detector as claimed in claim 9 wherein the demodulator comprises power normalizing means arranged to generate a power signal from the sampled signal and provide a normalized demodulated signal to the generator.

11. A differential detector as claimed in claim 1 wherein the demodulator includes power normalizing means arranged to generate a power signal from the sampled signal and provide a normalized demodulated signal to the sensing means.

12. A differential detector according to claim 1, wherein the sensing means further comprises a comparator arranged to compare said demodulated signal with a threshold provided by the offset signal to provide an output signal.

13. A differential detector according to claim 12, wherein said comparator provides a logical “1” output if said demodulated signal is larger than the threshold and otherwise output logical “0”.

14. Apparatus as claimed in claim 1, wherein the sensing means is arranged to sense the envelope of the demodulated signal by making the following determinations:
if xₙ<xₙ₋₁>xₙ₋₂ and xₙ₋₁>Min+threshold and xₙ₋₁<MAX, And if xₙ₋₁>Max or xₙ₋₁>dcₙ₋₁, then Max=xₙ₋₁
if xₙ>xₙ₋₁<xₙ₋₂ and xₙ₋₁<Max−threshold and xₙ₋₁>−MAX, And if xₙ₋₁<Min or xₙ₋₁<dcₙ₋₁, then Min=xₙ₋₁
where, xₙ, xₙ₋₁, xₙ₋₂ are respectively a sample at time n, a sample at time n−1 and a sample at time n−2 of said first input signal, dcₙ₋₁ is a low frequency component of the envelope of the demodulated signal at time n−1, Max and Min represent values of negative and positive peaks of the envelope of the demodulated signal, and threshold and MAX are preset constants.

15. Apparatus as claimed in claim 14 , wherein the threshold and MAX are proportional to a sampling duration, a modulation index or amplitude of the demodulated signal.

16. Apparatus as claimed in claim 2, wherein the sensing means is arranged to sense the envelope of the demodulated signal by making the following determinations:
xₙ<xₙ₋₁>xₙ₋₂ and xₙ₋₁<Min+threshold and xₙ₋₁<MAX, And if xₙ₋₁>Max or xₙ₋₁>dcₙ₋₁, then Max=xₙ₋₁
xₙ>xₙ₋₁<xₙ₋₁ and xₙ₋₁<Max−threshold and xₙ₋₁>−MAX, And if xₙ₋₁<Min or xₙ₋₁<dcₙ₋₁, then Min=xₙ₋₁
where, xₙ, xₙ₋₁, xₙ₋₂ are respectively a sample at time n, a sample at time n−1 and a sample at time n−2 of said first input signal, dcₙ₋₁ is a low frequency component of the envelope of the demodulated signal at time n−1, Max and Min represent values of negative and positive peaks of the envelope of the demodulated signal, and threshold and MAX are preset constants.

17. Apparatus as claimed in claim 16, wherein said filter is arranged to calculate a component of the offset signal of the form:
$$d {c}_{n} = ( 1 - {α}_{n} ) d {c}_{n - 1} + \frac{{α}_{n}}{2} ( Max + Min )$$
where, dcₙ is said frequency component of said input signal at time n, dcₙ₋₁ is said frequency component at time n−_{1,} and αₙ is a coefficient of the filter at time n.

18. A detector as claimed in claim 1 wherein the demodulated baseboard signal and the sampled signal comprise two signal components in phase quadrature.

19. A differential detector comprising:
a frequency converter arranged to convert an input signal into a demodulated baseband signal;
sampling means arranged to sample said demodulated baseband signal at a sampling frequency to provide a sampled signal;
a demodulator arranged to demodulate the sampled signal to provide a demodulated signal; and
a filter arranged to filter the demodulated signal to provide a filtered signal indicative of a frequency offset of the input signal and wherein the filter is arranged to have a bandwidth which decreases as a function of time.
